(19) United States
(12) Patent Application Publication
(10) Pub. No.: US 2003/0015602 A1
(43) Pub. Date: Jan. 23, 2003

(54) Insect shaped sprinkler nozzle

(76) Inventor: Masahiko Kamiya, Saitama City (JP)

Correspondence Address: Masahiko Kamiya, 3301-2, Sashiogi, Saitama City, Saitama-Pref., 331-0047, JP

(21) Appl. No.: 09/910,665

(22) Filed: Jul. 23, 2001

(51) Int. Cl. B05B 1/00

(52) U.S. Cl. 239/211

(57) ABSTRACT

Insect shaped sprinkler nozzle have safety and real shaped touch of sense and legs, and have the function of water supply from one part of its body to the direction of dripping, 90 degrees, 180 degrees, 360 degrees or mist spray.

### BACKGROUND OF THE INVENTION

Present invention is the real insect shaped sprinkler nozzle.

Sprinkler nozzle hitherto conventionally used has simple design which mainly is designed to only spray function. So, it is very difficult to make the decoration of beautiful garden and flowerpots totally.

Present invention was made to improve above described defect of heretofore conventionally used sprinkler nozzle.

### BRIEF DESCRIPTION OF THE DRAWINGS

Here will be introduced to one example of the present invention, which the position of water spray in that body is head part, and spray degree and direction are 90 degrees and backyard spray (FIGS. 1 and 2) and 360 degrees spray and circle (FIG. 3).

A preferred form of the present invention is illustrated in the accompanying drawings in which

FIGS. 1-a and 1-b are the view in front and side of a preferred embodiment of this invention. This is one body type.

FIGS. 2-a, 2-b, and 2-c are the view in front and side of a preferred embodiment of two parts type.

FIGS. 3-a, 3-b and 3-c are the view in front and side of a preferred embodiment of three parts type.

Numeral 1 is a pair of touch of sense, and numeral 2 are 3 pairs of legs. These are made by plastic and soft material so they are real shape and safety. Numeral 3 is nozzle parts, and it have two dented structure (numeral 6) in order to combine to numeral 7, and it have two small holes (numeral 8) in order to fix this insect shaped nozzle using wire or strings. Numeral 4 is the insect body parts, and it have two convexity structure (numeral 7) in order to combine to numeral 2. When it use exist nozzle structure parts (two parts), the flowing parts will be use. Numeral 5 is the head parts, having numeral 1. Numeral 9 is the water supply space in nozzle.

### DETAILED DESCRIPTION OF THE INVENTION

This sprinkler nozzle of this invention is insect shaped which have a pair of sense of touch and 6 legs, which are made of safety material, and are real shape. As water supply method, the function of water spray covers to dripping, 90 degrees 180 degrees, 360 degrees and mist water supply, and the direction of water supply are front, backyard, upside and down-side. It has the characteristic of variety of color and design freely for one species of insect. Beside, it has the small hole which fix itself through the wire or strings, the small fuck which hung itself or fixed pine which pierce and fix to itself. The following 3 examples are drawn about the type of water supply part on the head.

Explaining the drawings in more details of three examples; They have the water supply position in its head, and the spray method are 90 degrees or 360 degrees, and the direction of water spray is front or backyard. The insect is ladybird type.

1) In the case of one body type:

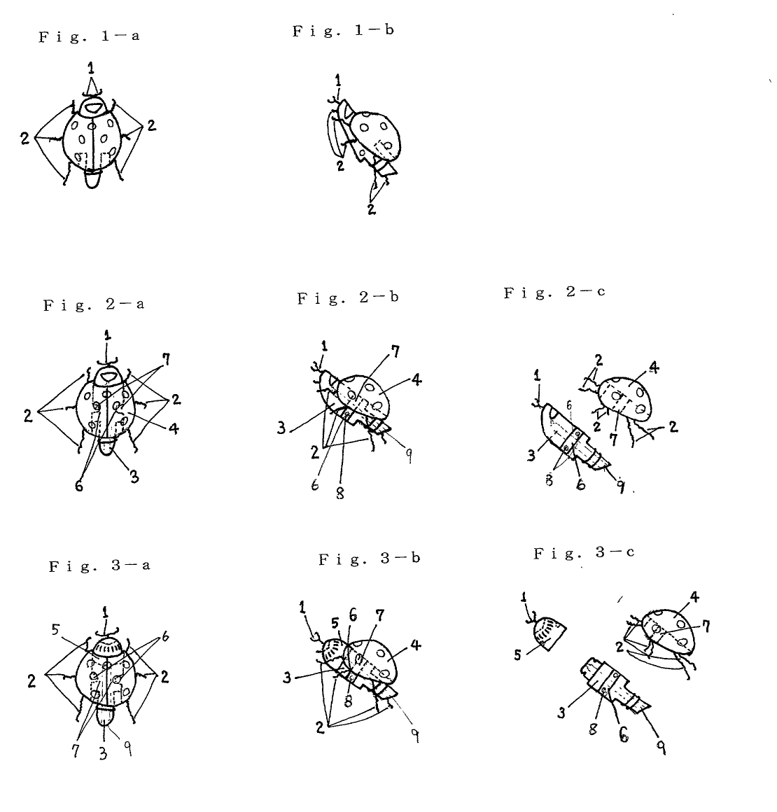

Example) All parts are consisted of one part (refer to FIGS. 1-a and 1-b).

2) In the case of two parts type:

Example) It consist of nozzle part, numeral 3 and insect body part, numeral 4 (refer to FIGS. 2-a, 2-b, 2-c). Nozzle part includes head part (touch of sense). And nozzle part has two dented structure, numeral 6, in order to combine to numeral 7. Insect body parts have six legs. And insect body part have two convexity structure, numeral 7, in order to combine to numeral 6. And they fit in each uneven part steadily.

3) In the case of three parts type (refer to FIG. 3):

Example) Nozzle part divides two parts, one is head part, numeral 5 and another is nozzle part, numeral 3 (refer to FIGS. 3-a, 3-b and 3-c). In this case, nozzle part 3 can use existing sprinkler nozzle part. Head part has the touch of sense. Nozzle part, numeral 3 has two dented structure, numeral 6, in order to combine to numeral 7. And it has small hole, numeral 8 for settling nozzle. Insect body part, numeral 4 have six legs. And insect body part have two convexity structure, numeral 7 in order to combine to numeral 6, and the nozzle part have two dented structure, numeral 6 in order to combine to numeral 7. And they fit in each uneven part steadily.

4) In the case of separated parts set type:

This is the kit type, mainly customer make it by myself. Parts are set in one kit, which include touch of sense, legs, body, and nozzle with head or nozzle and head.

What is claimed is:

1. This sprinkler nozzle is real insect shape which have touch of sense and 6 legs which made by safety material, and which become from one body or construction body (from two more parts) which have the function of water spray from one part of insect body.

2. Insect shaped sprinkler nozzle according to claim 1 wherein the design and color is changed freely, and wherein the water spray method is possible to any of dripped, 90 degrees 180 degrees, 360 degrees or mist spray, wherein the direction of spray is possible to any of front backyard, up-side or down-side, to one insect form.
